(19) United States
(12) Patent Application Publication
(10) Pub. No.: US 2016/0165279 A1
(43) Pub. Date: Jun. 9, 2016

(54) METHOD OF TRANSMITTING MESSAGES BETWEEN DISTRIBUTED AUTHORIZATION SERVER AND CONDITIONAL ACCESS MODULE AUTHENTICATION SUB-SYSTEM IN RENEWABLE CONDITIONAL ACCESS SYSTEM, AND RENEWABLE CONDITIONAL ACCESS SYSTEM HEADEND

(71) Applicant: ELECTRONICS AND TELECOMMUNICATIONS RESEARCH INSTITUTE, Daejeon (KR)

(72) Inventor: Han-Seung KOO, Daejeon (KR)

(21) Appl. No.: 14/943,307

(22) Filed: Nov. 17, 2015

(30) Foreign Application Priority Data
Dec. 4, 2014 (KR) 10-2014-0172958
Sep. 30, 2015 (KR) 10-2015-0137290

(51) Int. Cl. H04N 21/254; H04N 21/418; H04N 21/258; H04N 21/6334; H04N 21/266

(52) U.S. Cl. CPC H04N 21/2541; H04N 21/63345; H04N 21/26613; H04N 21/25816; H04N 21/4181; H04N 21/4182

(57) ABSTRACT

A Renewable Conditional Access System (RCAS) headend of an RCAS and a method of transmitting messages between a Distributed Authorization Center (DAC) and a Conditional Access Module (CAM) Authentication module Sub-System (CASS) included in the RCAS headend. The method of transmitting messages between a DAC and a CASS includes: transmitting, by a CASS, a subscription message for a subscription request to a DAC when receiving a subscription request from a Set-Top Box (STB); processing, by the DAC, the subscription of the STB based on the subscription message received from the CASS; and transmitting, by the DAC, a response message including security parameters to the CASS.

### CROSS-REFERENCE TO RELATED APPLICATIONS

This application claims the benefit of Korean Patent Application Nos. 10-2014-0172958 and 10-2015-0137290, filed Dec. 4, 2014 and Sep. 30, 2015, respectively, which are hereby incorporated by reference herein in their entirety.

### BACKGROUND

1. Technical Field

The present disclosure relates generally to technology for processing interfacing in a Renewable Conditional Access System (RCAS), and more particularly to technology for processing interfacing between a Distributed Authorization Center (DAC) and a Conditional Access Module (CAM) Authentication module Sub-System (CASS).

2. Description of the Related Art

Recently, the International Telecommunications Union Telecommunication Standardization Sector (ITU-T) has been developing an RCAS network protocol that can remotely renew Conditional Access Client Software (CACS) for digital cable broadcasting.

A technology regarding a conditional access system is disclosed in Korean Patent No. 10-0835984 (registered Jun. 2, 2008) entitled “Method and Apparatus for Renewing Conditional Access System for Digital Cable Broadcasting.” This technology is configured to, when a conditional access system renewal message is received from a headend, send a conditional access system renewal request message to a set-top box, and, when a system renewal response message is received from the set-top box, receive a system renewal program from the headend, applies the system renewal program, and provide notification of this to the set-top box and the headend.

However, the RCAS network protocol under development defines only message structures, and does not define content that is inserted into the payloads of messages.

Therefore, in light of recent tendency toward the extension of fields using an RCAS network, as in the field of IPTV, there is an increasing need to define content that is inserted into the payloads of messages based on the RCAS network protocol.

### SUMMARY

At least one embodiment of the present invention is intended to define content to be inserted into message payloads in the form of ASN. 1 in connection with messages transmitted between a DAC and a CASS in an RCAS.

At least one embodiment of the present invention is intended to effectively perform the authentication of an STB constituting part of an RCAS using messages transmitted between a DAC and a CASS as defined in the present invention.

At least one embodiment of the present invention is intended to efficiently transfer the result of the authentication of an STB to a CASS using messages transmitted between a DAC and the CASS as defined in the present invention.

In accordance with an aspect of the present invention, there is provided a method of transmitting messages between a Distributed Authorization Center (DAC) and a Conditional Access Module (CAM) Authentication module Sub-System (CASS) in a Renewable Conditional Access System (RCAS) headend of an RCAS, the method including: transmitting, by a CASS, a subscription message for a subscription request to a DAC when receiving a subscription request from a Set-Top Box (STB); processing, by the DAC, the subscription of the STB based on the subscription message received from the CASS; and transmitting, by the DAC, a response message including security parameters to the CASS.

The subscription message may include an ID corresponding to the CASS and a key pairing ID.

The key pairing ID may be generated by concatenating the ID of the CAM of the STB and the ID of the descrambler of the STB.

Processing the subscription of the STB may include: validating the pairing between the CAM and the descrambler based on the key pairing ID; and performing the authentication of the STB based on the result of the validation of the pairing.

Validating the pairing may include performing validation based on whether the ID of the CAM and the ID of the descrambler are present in a database of the DAC.

Transmitting the response message may include transmitting the response message including the result of the authentication.

Transmitting the response message may include transmitting the response message including a key pairing key when the pairing has been successfully validated.

Transmitting the response message may include transmitting the response message including the value signature of the signature of the key pairing key.

Each of the subscription message and the response message may be defined in the ASN.1 syntax format.

The subscription message and the response message may have different message type values.

The security parameters may include any one or more of the result of the authentication of the STB, values adapted to generate a session key, a key pairing key, and the value signature of the signature of the key pairing key.

The values adapted to generate a session key may include any one or more of a random value assigned to the STB by the DAC, and a Kc value calculated based on the random value and a Ki value.

The Ki value may be a number generated by a Centralized Authorization Center (CAC) corresponding to the STB, and a value inserted into the CAM of the STB.

The random value assigned to the STB by the DAC may be a value generated by the DAC and inserted into the CAM of the STB.

In accordance with another aspect of the present invention, there is provided a Renewable Conditional Access System (RCAS) headend of an RCAS, including: a Conditional Access Module (CAM) Authentication module Sub-System (CASS) configured to transmit a subscription message adapted to transfer a subscription request to a Distributed Authorization Center (DAC) when receiving a subscription request from a Set-Top Box (STB); and the DAC configured to process the subscription of the STB based on the subscription message received from the CASS, and to transmit a response message including security parameters to the CASS.

The subscription message may include an ID corresponding to the CASS and a key pairing ID.

The key pairing ID may be generated by concatenating the ID of the CAM of the STB and the ID of the descrambler of the STB.

The DAC may be further configured to validate the pairing between the CAM and the descrambler based on the key pairing ID, and to perform the authentication of the STB based on the result of the validation of the pairing.

The DAC may be further configured to transmit the response message including a key pairing key and the value signature of the signature of the key pairing key.

Each of the subscription message and the response message may be defined in the ASN.1 syntax format.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing RCAS headends, a CAC, a set-top box according to an embodiment of the present invention;

FIG. 2 is a block diagram showing an RCAS headend according to an embodiment of the present invention;

FIG. 3 is a diagram showing a message format exchanged between a DAC and a CASS in an RCAS headend according to an embodiment of the present invention;

FIG. 4 is a diagram showing an interface for transmitting/receiving messages between the DAC and CASS of an RCAS headend according to an embodiment of the present invention;

FIG. 5 is a diagram showing the ASN.1 syntax of a subscription message that is transmitted by a CASS to a DAC in an RCAS headend according to an embodiment of the present invention;

FIG. 6 is a diagram showing the ASN.1 syntax of a response message that is transmitted by a DAC to a CASS in an RCAS headend according to an embodiment of the present invention; and

FIG. 7 is an operation flowchart showing a method of transmitting messages between a DAC and a CASS in an RCAS headend according to an embodiment of the present invention.

### DETAILED DESCRIPTION

Embodiments of the present invention will be described in detail below with reference to the accompanying drawings. Redundant descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes and the like of components in the drawings may be exaggerated to make the description obvious.

First, terms and acronyms used herein are defined.

The term “conditional access” refers to the conditional authorization of access to cable service or content.

The term “scrambling” refers to the process of encrypting sounds, images or like so that an unauthenticated group or an unauthenticated user cannot use the sounds, the images or the like.

The term “descrambling” refers to the process of converting data, sounds, images or the like using a reverse scrambling function so that they can be used.

The term “Entitlement Control Message (ECM)” refers to information including information obtained by encrypting a control word and criteria for access to various services.

The term “Entitlement Management Message (EMM)” refers to information obtained by encrypting and sending entitlement to reception.

The acronym of “Conditional Access Client Software” is CACS.

The acronym of “Conditional Access Module” is CAM.

The acronym of “CAM Sub-System” is CASS.

The acronym of “Distributed Authorization Center” is DAC.

The acronym of “Renewable Conditional Access System” is RCAS.

A secure Conditional Access Client Software download sub-system corresponds to a secure CACS download sub-system.

Embodiments of the present invention are described in detail with reference to the accompanying drawings.

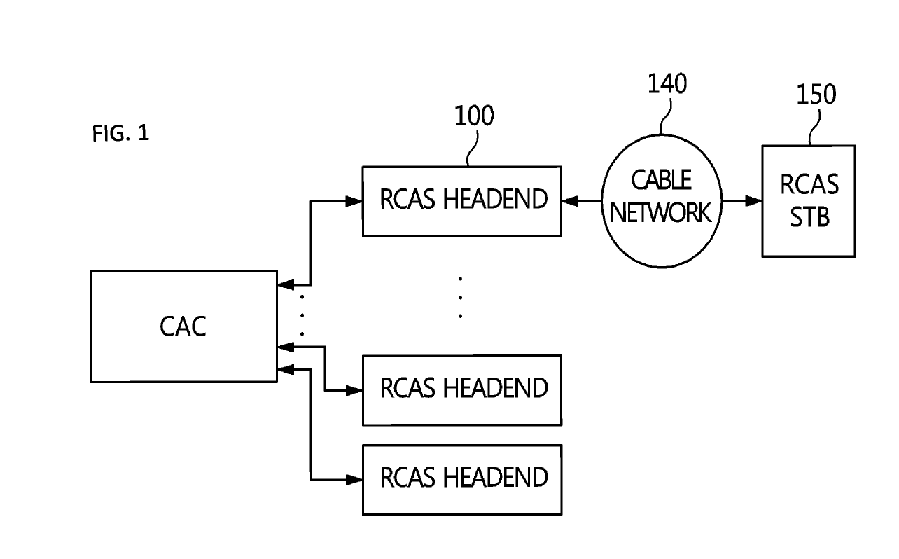

FIG. 1 is a block diagram showing RCAS headends, a Centralized Authorization Center (CAC), a Set-Top Box (STB) according to an embodiment of the present invention.

An RCAS includes a CAC, a plurality of RCAS headends, and an STB connected to each of the RCAS headends.

In this case, a conditional access system refers to a system that allows a digital receiver (STB) of a user to determine whether to receive a specific broadcast program.

In this case, the conditional access system corresponds to technology for renewing CACS, and uses a method of securely downloading new CACS over a bidirectional digital cable.

That is, the conditional access system refers to a system that allows only users who have acquired access rights through a legitimate license fee or the like to view a program.

In this case, the conditional access system may transfer a private key to the STB using a smart card having the unique personal information of a subscriber.

In this case, the STB that has received the private key may view a specific broadcast program using the private key.

In this case, each of the headends 100 includes a DAC, a CASS, and an SCDSS.

In this case, the plurality of headends 100 may be present in a single CAC. The reason for this is that only a single headend 100 cannot covers an overall service area.

That is, a single DAC is present in each of the headends 100, and a plurality of DACs is connected to a single CAC.

The reason for this is to efficiently control an authentication procedure for a plurality of STBs.

As shown in FIG. 1, Multiple Service Operators (MSOs) have a single CAC, and a single DAC is provided in each of the plurality of headends.

Accordingly, the CAC and DACs have a 1:N correspondence, and the DACs and CASSs have a 1:1 correspondence.

In this case, the STB may include a CAM and a descrambler.

A CAM refers to a PC card-type electronic device that is inserted into a subscriber terminal device (an STB or the like) to perform conditional access.

In this case, the CAM provides a slot into which a smart card can be inserted.

In this case, when a scrambled broadcast signal and a control command are transferred to the STB, the CAM may check access rights using a conditional access function present in the smart card.

In this case, the descrambler inside the STB may provide a complete image by descrambling the scrambled signal.

Scrambling refers to technology that encodes or encrypts signals using an appropriate method, thereby enabling the scrambled signals not to be understood by a general recipient. For example, when normal screens are encrypted and transmitted in a scrambled state, a general recipient cannot receive the normal screens.

In this case, when the scrambled screens are descrambled, the normal screens are received.

In this case, to descramble the scrambled screens, a specific decoder and an encryption key are required. Using a method of providing the encryption key only to specific recipients, the normal screens may be provided only to the specific recipients.

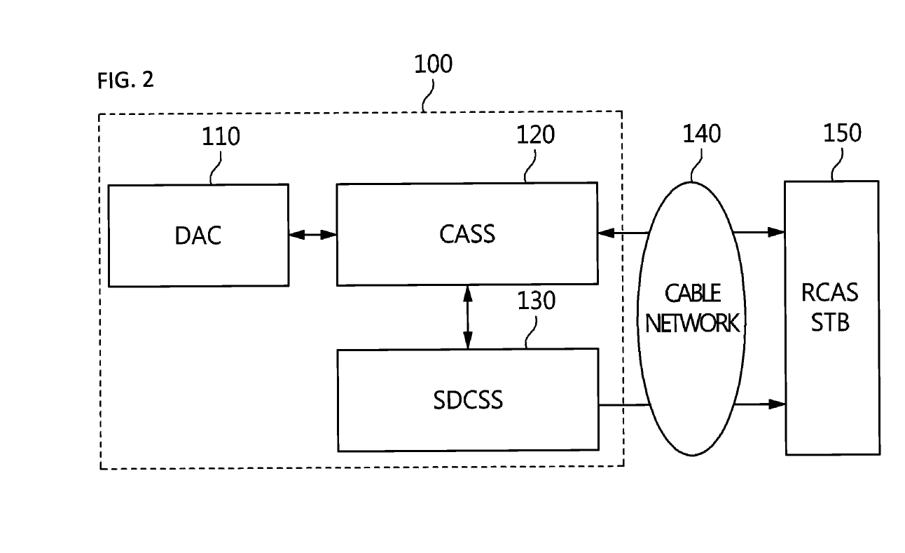

FIG. 2 is a block diagram showing an RCAS headend 100 according to an embodiment of the present invention.

Referring to FIG. 2, the RCAS headend 100 according to the present embodiment includes a DAC 110, a CASS 120, and an SCDSS 130. The RCAS headend 100 is connected to an RCAS STB 150 over a cable network 140.

In this case, the RCAS headend 100 is located in a cable broadcasting station.

In this case, the CASS 120 functions to establish a secure channel between the RCAS STB 150 and the RCAS headend 100.

In this case, the SCDSS 130 functions to send a conditional access client image down to the RCAS STB 150 over the secure channel after the secure channel has been established between the headend 100 and the RCAS STB 150.

In this case, the DAC 110 may function to issue certificates to RCAS headend servers and manage the certificates.

In this case, the DAC 110 may generate the unique IDs of the headend server.

In this case, the DAC 110 may validate and manage the pairing between a CAM and a descrambler inside the STB.

In this case, the DAC 110 may manage parameters required for the authentication of STBs.

In this case, the DAC 110 may process the subscription and subscription cancellation of the retail and lease RCAS STB 150 received from the CASS 120.

In this case, the CAC may process the subscription and subscription cancellation of RCAS-related servers and RCAS STBs 150 located in headends that are separately present.

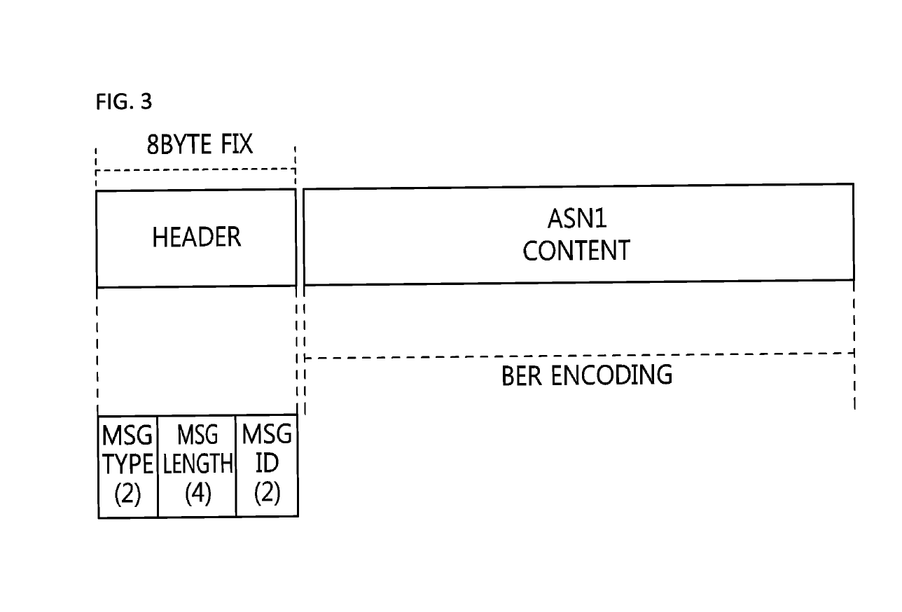

FIG. 3 is a diagram showing a message format between a DAC and a CASS exchanged in an RCAS headend according to an embodiment of the present invention.

Referring to FIG. 3, the message format exchanged between the DAC and the CASS may be basically divided into a message header and message content.

In this case, values encoded in ASN.1 format are inserted into message content.

ASN. 1 is a protocol that was defined by the ITU-T and defines data exchange over a network. ASN. 1 belongs to the presentation layer, i.e., one of the seven layers of the OSI reference model, and refers to a notation for describing data structures.

Currently, the ITU-T Study Group (SG) 9 defines only message structures, but does not define content that is inserted into message payloads.

That is, the present invention is intended to define content that is inserted into message payloads using the ASN.1 syntax, which is a protocol description method defined by the ITU/ISO/IEC. When the method defined by the present invention is employed, information for the authentication of the RCAS STB may be effectively transferred from the CASS to the DAC, and the result of the authentication may be effectively transferred from the DAC to the CASS.

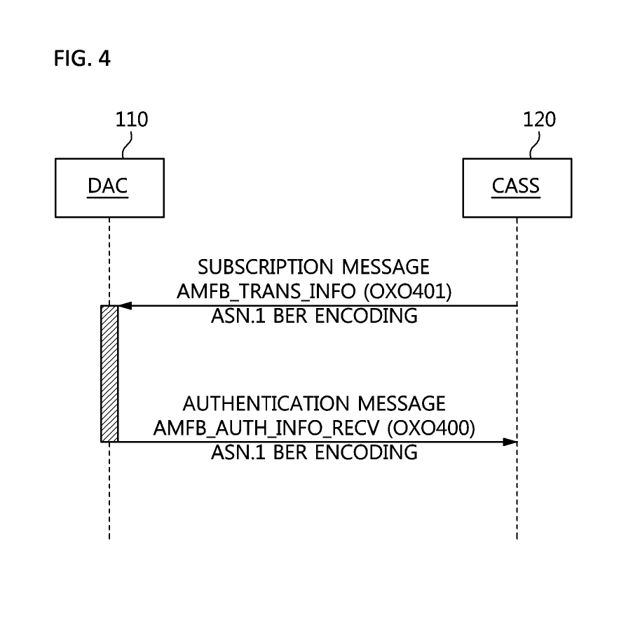

FIG. 4 is a diagram showing an interface for transmitting/receiving messages between the DAC and CASS of an RCAS headend according to an embodiment of the present invention.

First, referring to FIG. 4, the transmission and reception of messages between a DAC 110 and a CASS 120 are described.

The CASS 120 transmits a subscription message AMFB_TRANS_INFO to the DAC 110.

In this case, the subscription message may be a message for a subscription request when a subscription request is transferred from an STB to the CASS 120.

In this case, the subscription message may be encoded in the form of the ASN.1 syntax.

In this case, the message type value of the subscription message may be 0x0401.

Descriptions of parameters used for subscription messages and response messages are listed in Table 1 below:

TABLE 1

| Parameter Name | Description |
|---|---|
| DSC_ID | This parameter is the ID of a descrambler, and has |
| | a size of 40 bytes. |
| CAM_ID | This parameter is the ID of a CAM, and has |
| | a size of 8 bytes. |
| KeyPairingID | This parameter is generated by concatenating |
| | CAM_ID and DSC_ID. |
| KPK | This parameter is the acronym of “Key Pairing |
| | Key,” and is a value generated by an authorization |
| | center after a key pairing ID has been validated. |
| RAND | This parameter is a random number having a |
| | size of 320 bits. |
| Ki | This parameter is a previously shared key having a |
| | size of 128 bits. An authorization center previously |
| | sets three Kis for each CAM. In this case, Ki is |
| | generated using a random number generation function. |

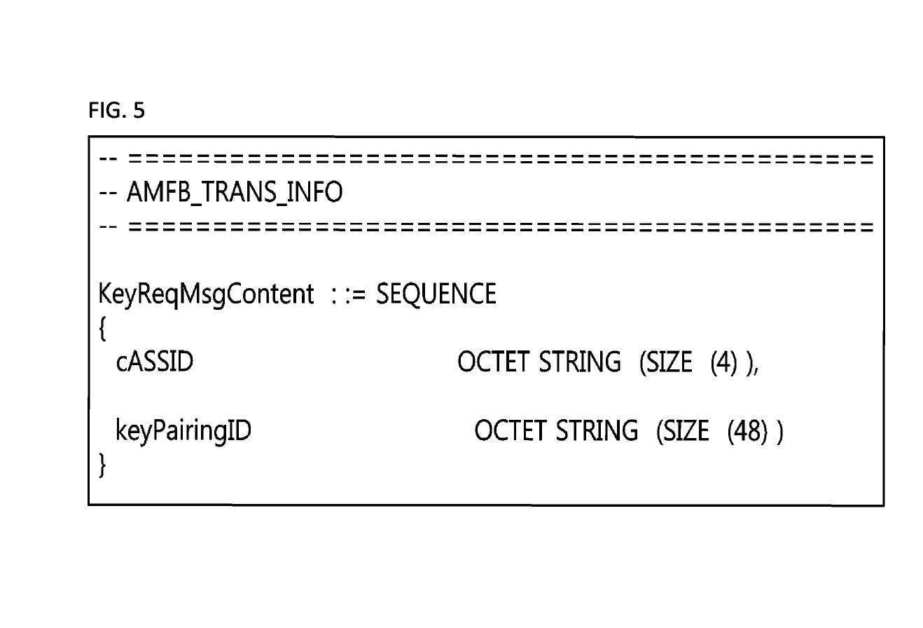

Referring to FIG. 5, a subscription message is described below.

FIG. 5 is a diagram showing the ASN.1 syntax of a subscription message. In this drawing, the subscription message includes a CASS ID and a key pairing ID.

In this case, the key pairing ID is a value that is transmitted by the CAM inside an STB, and is generated by concatenating the CAM ID and the descrambler ID DSC_ID.

The DAC 110 may process the subscription of the STB based on a subscription message received from the CASS 120.

In this case, the DAC 110 that has received the subscription message may validate the pairing between the CAM and the descrambler based on a key pairing ID inside the subscription message, and may perform the authentication of the STB based on the result of the validation of the pairing.

In this case, the DAC 110 may transmit a response message including the result of the authentication of the STB.

In this case, the DAC 110 may validate the pairing between the CAM and the descrambler based on whether CASS_ID and DSC_ID included in the key pairing ID are present in a database inside the DAC 110.

In this case, the DAC 110 may generate a key pairing key when the pairing has been successfully validated.

In this case, the key pairing key may be used to encrypt or decrypt a control word.

The control word refers to a key that is used to descramble and scramble broadcast content or the like.

Furthermore, the generated key pairing key may be transmitted to the CASS 120 in the state of being included in a response message.

Furthermore, the value signature of the signature of the key pairing key may be also transmitted to the CASS 120 in the state of being included in the response message.

In this case, the subscription of the STB may be processed based on the result of the authentication of the STB.

In this case, the DAC 110 may transmit a response message AMFB_AUTH_INFO_RECV, including security parameters, to the CASS 120.

In this case, the response message may be also encoded in the form of the ASN.1 Syntax.

In this case, the message type value of the response message may be 0x0400. That is, the message type value of the response message may be different from that of the subscription message.

In this case, the security parameters refer to parameters that are generated by utilizing Ki and the operator variant algorithm configuration field of the STB.

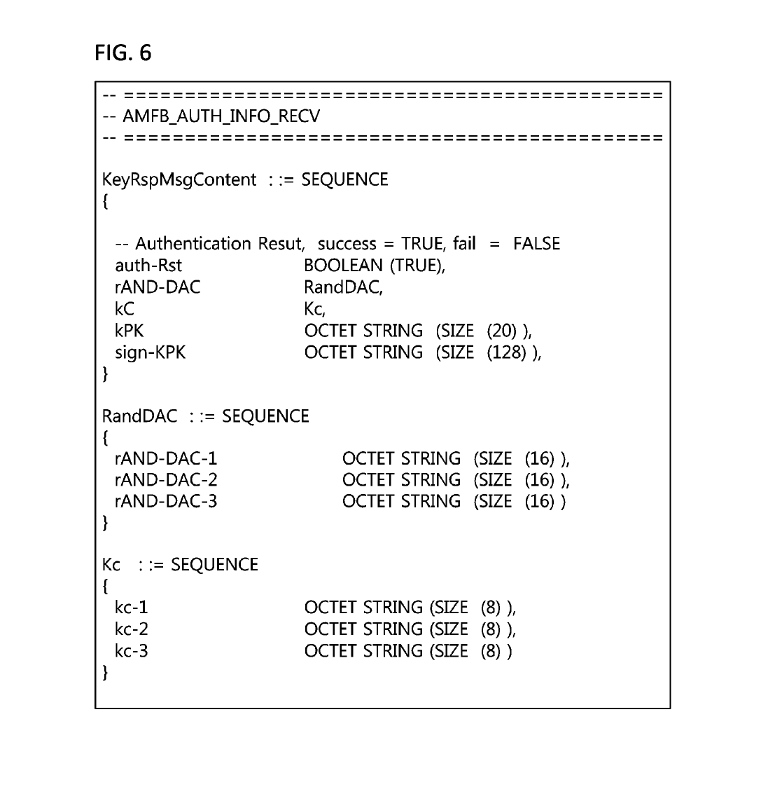

In this case, the security parameters are described in detail below with reference to FIG. 6.

Referring to FIG. 6, the ASN.1 syntax of a response message that the DAC 110 transmits to the CASS 120 is shown.

First, the response message may include the result of the authentication of an STB. In FIG. 6, the result of the authentication of the STB is represented by auth_Rst.

In this case, when the authentication of the STB succeeds, an auth_Rst value is represented as “true.”

Furthermore, when the authentication of the STB fails, an auth_Rst value is represented as “false.”

Furthermore, values for generating a session key may be included in the response message.

In FIG. 6, Kc and RandDAC (or, “rand_dac”) are shown as the values for generating a session key.

RandDAC is a value that is generated by the DAC to generate a session key, and may be inserted into the CAM of the RCAS STB.

In this case, RandDAC may be inserted into the CAM during the manufacture of the STB.

Furthermore, RandDAC may vary according to each STB, and corresponds to a number that is randomly generated by the DAC.

Kc corresponds to an input value for generating a session key.

Furthermore, Kc may be generated by means of a random number generation function using a Ki value and the value of RandDAC as inputs.

In this case, the Ki value is a value that is randomly generated for each STB by the CAC, and may be inserted into the CAM during the manufacture of the STB.

Furthermore, a key pairing key KPK may be included in a response message.

Furthermore, the value signature sign-KPK of the signature of the key pairing key may be included in the response message.

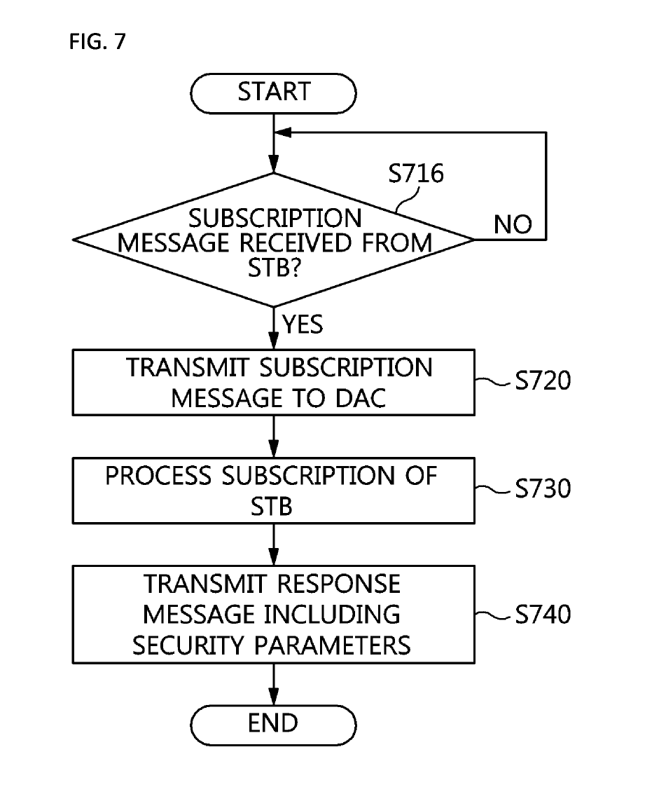

FIG. 7 is an operation flowchart showing a method of transmitting messages between a DAC and a CASS in an RCAS headend according to an embodiment of the present invention.

Referring to FIG. 7, it is determined first whether the CASS has received a subscription message from the STB at step S710, and a subscription message for a subscription request is transmitted to the DAC if a subscription message has been received at step S720.

In this case, the subscription message may refer to a message for a subscription request when a subscription request is transferred from an STB to the CASS.

In this case, the subscription message may be encoded in the form of the ASN.1 syntax.

In this case, the message type value of the subscription message may be 0x0401.

The subscription message includes a CASS ID and a key pairing ID.

In this case, the key pairing ID is a value that is transmitted by the CAM inside the STB, and is generated by concatenating the CAM ID and the descrambler ID DSC_ID.

Furthermore, the DAC 110 processes the subscription of the STB based on a subscription message received from the CASS 120 at step S730.

In this case, the DAC 110 that has received the subscription message may validate the pairing between the CAM and the descrambler based on a key pairing ID inside the subscription message, and may perform the authentication of the STB based on the result of the validation of the pairing.

In this case, the DAC 110 may validate the pairing between the CAM and the descrambler based on whether CASS_ID and DSC_ID included in the key pairing ID are present in a database inside the DAC 110.

In this case, the DAC 110 may generate a key pairing key when the pairing has been successfully validated.

In this case, the subscription of the STB may be processed based on the result of the authentication of the STB.

Furthermore, the DAC transmits a response message including security parameters at step S740.

In this case, the DAC 110 may transmit a response message including the result of the authentication of the STB.

Furthermore, the generated key pairing key may be transmitted to the CASS 120 in the state of being included in the response message.

Furthermore, the value signature of the signature of the key pairing key may be also transmitted to the CASS 120 in the state of being included in the response message.

In this case, the security parameters may correspond to RandDAC and Ki, as shown in FIG. 4. The description of these parameters has been already given above in conjunction with FIG. 4.

The method for transmitting messages between a DAC and a CASS according to the present invention may be implemented in the form of program instructions and then recorded in a computer-readable storage medium. The computer-readable storage medium may include program instructions, data files, and data structures solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-read only memory (ROM) and a digital versatile disk (DVD), magneto-optical media, such as a floptical disk, ROM, random access memory (RAM), and flash memory. Examples of the program instructions include machine code, such as code created by a compiler, and high-level language code executable by a computer using an interpreter.

As described above, the RCAS headend of the RCAS and the method for transmitting messages between a DAC and a CASS inside the headend according to the present invention are not limited to the configurations and methods of the above-described embodiments, but some or all of the embodiments may be configured to be selectively combined such that the embodiments can be modified in various manners.

According to at least one embodiment of the present invention, content to be inserted into message payloads can be defined in the form of ASN. 1 in connection with messages transmitted between the DAC and the CASS in the RCAS, thereby enabling the function of the RCAS to effectively operate.

According to at least one embodiment of the present invention, the authentication of the STB constituting part of the RCAS can be effectively performed using messages transmitted between the DAC and the CASS as defined in the present invention.

According to at least one embodiment of the present invention, the result of the authentication of an STB can be efficiently transferred to the CASS using messages transmitted between the DAC and the CASS as defined in the present invention.

Although the preferred embodiments of the present invention have been disclosed for illustrative purposes, those skilled in the art will appreciate that various modifications, additions and substitutions are possible without departing from the scope and spirit of the invention as disclosed in the accompanying claims.

What is claimed is:

1. A method of transmitting messages between a Distributed Authorization Center (DAC) and a Conditional Access Module (CAM) Authentication module Sub-System (CASS) in a Renewable Conditional Access System (RCAS) headend of an RCAS, the method comprising:
transmitting, by a CASS, a subscription message for a subscription request to a DAC when receiving a subscription request from a Set-Top Box (STB);
processing, by the DAC, subscription of the STB based on the subscription message received from the CASS; and
transmitting, by the DAC, a response message including security parameters to the CASS.

2. The method of claim 1, wherein the subscription message comprises an ID corresponding to the CASS and a key pairing ID.

3. The method of claim 2, wherein the key pairing ID is generated by concatenating an ID of a CAM of the STB and an ID of a descrambler of the STB.

4. The method of claim 3, wherein processing the subscription of the STB comprises:
validating a pairing between the CAM and the descrambler based on the key pairing ID; and
performing authentication of the STB based on a result of the validation of the pairing.

5. The method of claim 4, wherein validating the pairing comprises performing validation based on whether the ID of the CAM and the ID of the descrambler are present in a database of the DAC.

6. The method of claim 5, wherein transmitting the response message comprises transmitting the response message including the result of the authentication.

7. The method of claim 5, wherein transmitting the response message comprises transmitting the response message including a key pairing key when the pairing has been successfully validated.

8. The method of claim 7, wherein transmitting the response message comprises transmitting the response message including a value signature of a signature of the key pairing key.

9. The method of claim 1, wherein each of the subscription message and the response message is defined in an ASN.1 syntax format.

10. The method of claim 9, wherein the subscription message and the response message have different message type values.

11. The method of claim 1, wherein the security parameters comprise any one or more of a result of authentication of the STB, values adapted to generate a session key, a key pairing key, and a value signature of a signature of the key pairing key.

12. The method of claim 11, wherein the values adapted to generate a session key comprise any one or more of a random value assigned to the STB by the DAC, and a Kc value calculated based on the random value and a Ki value.

13. The method of claim 12, wherein the Ki value is a number generated by a Centralized Authorization Center (CAC) corresponding to the STB, and a value inserted into a CAM of the STB.

14. The method of claim 12, wherein the random value assigned to the STB by the DAC is a value generated by the DAC and inserted into a CAM of the STB.

15. A Renewable Conditional Access System (RCAS) headend of an RCAS, comprising:
a Conditional Access Module (CAM) Authentication module Sub-System (CASS) configured to transmit a subscription message adapted to transfer a subscription request to a Distributed Authorization Center (DAC) when receiving a subscription request from a Set-Top Box (STB); and
the DAC configured to process subscription of the STB based on the subscription message received from the CASS, and to transmit a response message including security parameters to the CASS.

16. The RCAS headend of claim 15, wherein the subscription message comprises an ID corresponding to the CASS and a key pairing ID.

17. The RCAS headend of claim 16, wherein the key pairing ID is generated by concatenating an ID of a CAM of the STB and an ID of a descrambler of the STB.

18. The RCAS headend of claim 17, wherein the DAC is further configured to validate a pairing between the CAM and the descrambler based on the key pairing ID, and to perform authentication of the STB based on a result of the validation of the pairing.

19. The RCAS headend of claim 18, wherein the DAC is further configured to transmit the response message including a key pairing key and a value signature of a signature of the key pairing key.

20. The RCAS headend of claim 19, wherein each of the subscription message and the response message is defined in an ASN.1 syntax format.
